(19) United States
(12) Patent Application Publication
(10) Pub. No.: US 2025/0175239 A1
(43) Pub. Date: May 29, 2025

(54) BEAM MANAGEMENT METHOD AND COMMUNICATION DEVICE

(71) Applicant: Beijing Xiaomi Mobile Software Co., Ltd., Beijing (CN)

(72) Inventor: Liangang CHI, Beijing (CN)

(73) Assignee: Beijing Xiaomi Mobile Software Co., Ltd., Beijing (CN)

(21) Appl. No.: 18/836,504

(22) PCT Filed: Feb. 8, 2022
(86) PCT No.: PCT/CN2022/075566

§ 371 Date: Aug. 7, 2024

(51) Int. Cl. H04B 7/06; H04B 17/309; H04L 5/00

(52) U.S. Cl. CPC H04B 7/06968; H04B 17/309; H04L 5/0048

(57) ABSTRACT

Beam management methods and communication devices are provided. One of the method is performed by a network device and includes sending first indication information to a terminal device. The first indication information is configured to indicate configuration information of a reference signal used for a beam measurement. The reference signal corresponds to one or more grades. Based on the configuration information of the reference signal in the first indication information, the terminal device performs the beam measurement.

### CROSS REFERENCE TO RELATED APPLICATIONS

The present disclosure is the U.S. national phase application of International Application No. PCT/CN2022/075566 filed on Feb. 8, 2022, the content of which is incorporated herein by reference in its entirety for all purposes.

### TECHNICAL FIELD

The present disclosure relates to the field of communication technology, in particular, to beam management methods and communication devices.

### BACKGROUND

With the increasing demand for communication, low-frequency wireless spectrum resources are about to be depleted, and the development and utilization of high-frequency millimeter wave and even terahertz communication technology have become an inevitable trend.

### SUMMARY

In the first aspect, the present disclosure provides a beam management method, which is performed by a network device and includes: sending first indication information to a terminal device, wherein the first indication information is configured to indicate configuration information of a reference signal used for a beam measurement, and the reference signal corresponds to one or more grades.

In the second aspect, the present disclosure provides a beam management method, which is performed by a terminal device and includes: receiving first indication information sent by a network device, wherein the first indication information is configured to indicate configuration information of a reference signal used for a beam measurement, and the reference signal corresponds to one or more grades.

In the third aspect, the present disclosure provides a communication apparatus, which is on the network device side and includes: a transceiver module configured to send first indication information to a terminal device, wherein the first indication information is configured to indicate configuration information of a reference signal used for a beam measurement, and the reference signal corresponds to one or more grades.

In the fourth aspect, the present disclosure provides a communication apparatus, which is on the terminal device side and includes: a transceiver module configured to receive first indication information sent by a network device, wherein the first indication information is configured to indicate configuration information of a reference signal used for a beam measurement, and the reference signal corresponds to one or more grades.

In the fifth aspect, the present disclosure provides a communication device including a processor, and when the processor executes a computer program in a memory, the method described in the first aspect is caused to be implemented.

In the sixth aspect, the present disclosure provides a communication device including a processor, and when the processor executes a computer program in a memory, the method described in the second aspect is caused to be implemented.

In the seventh aspect, the present disclosure provides a communication device including a processor and a memory for storing a computer program, wherein the processor is configured to execute the computer program stored in the memory to cause the method described in the first aspect to be implemented.

In the eighth aspect, the present disclosure provides a communication device including a processor and a memory for storing a computer program, wherein the processor is configured to execute the computer program stored in the memory to cause the method described in the second aspect to be implemented.

In the ninth aspect, the present disclosure provides a communication device including a processor and an interface circuit, wherein the interface circuit is configured to receive and transmit code instructions to the processor, and the processor is configured to run the code instructions to cause the method described in the first aspect to be implemented.

In the tenth aspect, the present disclosure provides a communication device including a processor and an interface circuit, wherein the interface circuit is configured to receive and transmit code instructions to the processor, and the processor is configured to run the code instructions to cause the method described in the second aspect to be implemented.

In the eleventh aspect, the present disclosure provides a beam management system including the communication apparatus as described in the third aspect and the communication apparatus as described in the fourth aspect, or a beam management system including the communication device as described in the fifth aspect and the communication device as described in the sixth aspect, or a beam management system including the communication device as described in the seventh aspect and the communication device as described in the eighth aspect, or a beam management system including the communication device as described in the ninth aspect and the communication device as described in the tenth aspect.

In the twelfth aspect, the present disclosure provides a non-transitory computer-readable storage medium for storing instructions used for a network device. The stored instructions when executed cause the network device to perform the method described in the first aspect.

In the thirteenth aspect, the present disclosure provides a non-transitory computer-readable storage medium for storing instructions used for a terminal device. The stored instructions when executed cause the terminal device to perform the method described in the second aspect.

In the fourteenth aspect, the present disclosure provides a computer program product including a computer program. The computer program, when running on a computer, causes the computer to implement the method described in the first aspect.

In the fifteen aspect, the present disclosure provides a computer program product including a computer program. The computer program, when running on a computer, causes the computer to implement the method described in the second aspect.

In the sixteenth aspect, the present disclosure provides a chip system including at least one processor and an interface for supporting a network device in achieving the functions related to the first aspect, such as determining or processing at least one of the data and information involved in the above method. In some embodiments, the chip system further includes a memory for storing necessary computer programs and data for the network device. The chip system can be composed of chips or include chips and other discrete devices.

In the seventeenth aspect, the present disclosure provides a chip system including at least one processor and an interface for supporting a terminal device in achieving the functions related to the second aspect, such as determining or processing at least one of the data and information involved in the above method. In some embodiments, the chip system further includes memory for storing necessary computer programs and data for the terminal device. The chip system can be composed of chips or include chips and other discrete devices.

In the eighteenth aspect, the present disclosure provides a computer program, which when is running on a computer, causes the computer to implement the method described in the first aspect.

In the nineteenth aspect, the present disclosure provides a computer program, which when is running on a computer, causes the computer to implement the method described in the second aspect.

### BRIEF DESCRIPTION OF THE DRAWINGS

In order to provide a clearer explanation of technical solutions in embodiments of the present disclosure or in the background, drawings required for use in embodiments of the present disclosure or in the background will be explained in the following.

FIG. 1 is a schematic diagram of an architecture of a communication system according to embodiments of the present disclosure;

FIG. 2 is a flowchart of a beam management method according to embodiments of the present disclosure;

FIG. 3 is a flowchart of a beam management method according to embodiments of the present disclosure;

FIG. 4 is a flowchart of a beam management method according to embodiments of the present disclosure;

FIG. 5 is a flowchart of a beam management method according to embodiments of the present disclosure;

FIG. 6 is a flowchart of a beam management method according to embodiments of the present disclosure;

FIG. 7 is a flowchart of a beam management method according to embodiments of the present disclosure;

FIG. 8 is a schematic diagram of a structure of a communication apparatus according to embodiments of the present disclosure;

FIG. 9 is a schematic diagram of a structure of a communication device according to embodiments of the present disclosure; and

FIG. 10 is a schematic diagram of a structure of a chip according to embodiments of the present disclosure.

### DETAILED DESCRIPTION

Exemplary embodiments will be described in detail here, with examples thereof shown in the drawings. When referring to the drawings, unless otherwise indicated, the same numbers in different drawings represent the same or similar elements. The embodiments described in the following do not represent all embodiments consistent with the present disclosure. Instead, these embodiments are only examples of devices and methods consistent with some aspects of the present disclosure as described in the appended claims.

For ease of understanding, the terms involved in the present disclosure will be introduced first in the following.

### 1. Reference Signal (RS)

The reference signal is a “pilot” signal, which is a known signal provided by the transmitting end to the receiving end for channel estimation or channel sensing. It can be terminal device for coherent detection, demodulation, or beam measurement, or used by the network device for coherent detection, monitoring, or channel quality measurement, etc.

### 2. Quasi Co-Location (QCL)

The antenna port QCL is a channel state assumption between antenna ports. If two antenna ports are said to be quasi co-located, the large-scale properties of the channel over which a symbol on one antenna port is conveyed can be inferred from the channel over which a symbol on the other antenna port is conveyed.

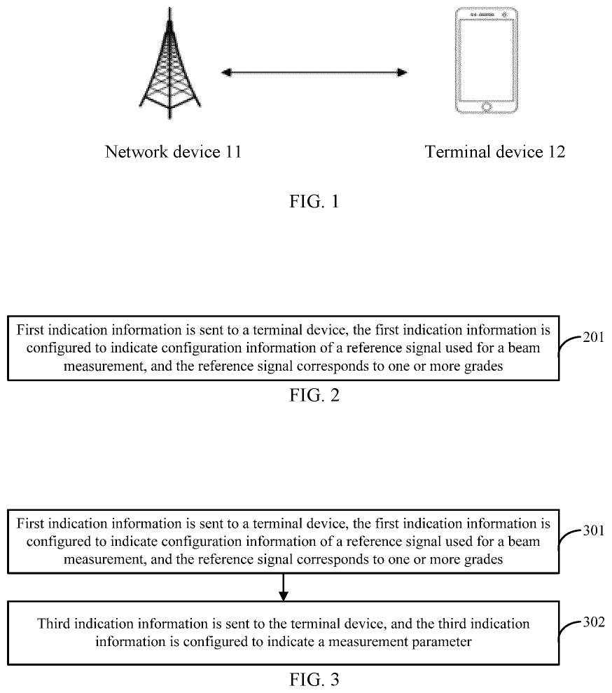

Reference is made to FIG. 1, a schematic diagram of an architecture of a communication system according to embodiments of the present disclosure. The communication system can include, but is not limited to, a network side device and a terminal device. The number and forms of devices shown in FIG. 1 are for example only and do not constitute a limitation on embodiments of the present disclosure. In practical applications, two or more network side devices and two or more terminal devices can be included. The communication system shown in FIG. 1 includes a network side device 11 and a terminal device 12 as an example.

It should be noted that technical solutions provided in embodiments of the present disclosure can be applied to various communication systems, such as the Long Term Evolution (LTE) system, the 5th generation (5G) mobile communication system, the 5G New Radio (NR) system, or other new mobile communication systems in the future.

The network side device 11 in embodiments of the present disclosure is an entity on the network side for transmitting or receiving signals. For example, the network side device 11 can be an evolved NodeB (eNB), a transmission reception point (TRP), a next generation NodeB (gNB) in the NR system, a base station in other future mobile communication systems, or an access point in wireless fidelity (WiFi) systems, etc. Embodiments of the present disclosure do not limit the specific technology and device form adopted by the network side device. The network side device provided in embodiments of the present disclosure can include a central unit (CU) and a distributed unit (DU). The CU can also be referred to as a control unit. The CU-DU structure can separate the protocol layer of the network side device, for example, the base station, with some protocol layer functions being placed in the CU under centralized control, and the remaining or all protocol layer functions being distributed in the DU, where DU is centrally controlled by CU.

The terminal device 12 in embodiments of the present disclosure is an entity on the user side for receiving or transmitting signals, such as a mobile phone. The terminal device can also be referred to as the terminal, the user equipment (UE), the mobile station (MS), the mobile terminal (MT), etc. The terminal device can include devices having communication capabilities, such as cars, smart cars, mobile phones, wearable devices, and Pads, or devices having wireless transmission and reception capabilities, such as computers, virtual reality (VR) terminals, augmented reality (AR) terminals, wireless terminals in industrial control, wireless terminals in self-driving, wireless terminals in remote medical surgery, wireless terminals in smart grid, wireless terminals in transportation safety, wireless terminals in smart city, and wireless terminals in smart home. Embodiments of the present disclosure do not limit the specific technology and device form adopted by the terminal device.

It can be understood that the communication system described in embodiments of the present disclosure is intended to provide a clearer explanation of technical solutions in the present disclosure, and does not constitute a limitation on the present disclosure. Those of ordinary skill in the art can realize that with the evolution of the system architecture and the emergence of new business scenarios, the technical solutions provided in the embodiments of the present disclosure are also applicable to similar technical problems.

The beam management method and the beam management apparatus provided by the present disclosure will be introduced in the following in detail in conjunction with the drawings.

Reference is made to FIG. 2, in which a flowchart of a beam management method according to embodiments of the present disclosure is shown. The method is performed by a network device. As shown in FIG. 2, the method can include, but is not limited to, the following steps.

In step 201, first indication information is sent to a terminal device, the first indication information is configured to indicate configuration information of a reference signal used for a beam measurement, and the reference signal corresponds to one or more grades.

In some embodiments of the present disclosure, in order to perform the beam measurement on millimeter waves or terahertz waves, the network device can configure multiple grades of reference signals used for measuring the millimeter waves, so as to indicate to the terminal device the configuration information of the reference signal corresponding to one or more grades. Based on the configuration information of the reference signal, the terminal device can complete the measurement on the millimeter waves.

In some embodiments of the present disclosure, the configuration information can include an index number corresponding to the reference signal, and a time domain position and a frequency domain position where the reference signal is located, etc., which is not limited by the present disclosure.

In some embodiments of the present disclosure, the index number corresponding to the reference signal can be used to determine the reference signal. The index number corresponding to the reference signal can correspond to the grade of the reference signal. Different index numbers represent different grades of reference signals. In some embodiments, if the grade of the reference signal is divided into grade one, grade two, and grade three, the index number corresponding to the reference signal can refer to an index path of the reference signal in a grade tree. The grade tree includes index numbers being of multiple grades and path relationships between each of the index numbers. The beam widths corresponding to the index numbers being of different grades are different.

In some embodiments, the grade corresponding to the reference signal can be determined based on the beam width of the reference signal, and the grade is configured to reflect the beam width of the reference signal.

In some embodiments, the grade value corresponding to the reference signal is correlated with the beam width of the reference signal. In some embodiments, if the grade value of the reference signal is positively correlated with the beam width, and the grade value of the reference signal includes grade one, grade two, and grade three, the beam width corresponding to the reference signal with a grade value of grade one has a wide width, the beam width corresponding to the reference signal with a grade value of grade two has a medium width, and the beam width corresponding to the reference signal with a grade value of grade three has a narrower width. In some embodiments, if the grade value of the reference signal is negatively correlated with the beam width, the beam width corresponding to the reference signal with a grade value of grade three has a wide width, the beam width corresponding to the reference signal with a grade value of grade two has a medium width, and the beam width corresponding to the reference signal with a grade value of grade one has a narrower width.

It should be noted that when the grade value is positively or negatively correlated with the beam width, the above corresponding relationship between the grade value and the beam width is only illustrative and cannot be used as a restrictive description related to the grade value and the beam width in the present disclosure.

In some embodiments, the network device can also send second indication information to the terminal device, and the second indication information is configured to indicate that a grade value corresponding to the reference signal is positively or negatively correlated with a beam width of the reference signal.

In this way, after receiving the second indication information, the terminal device can determine that the grade value corresponding to the reference signal is positively or negatively correlated with the beam width of the reference signal. The terminal device can then determine the beam width corresponding to the reference signal, based on the correlation relationship and the grade value corresponding to the reference signal having been indicated.

According to embodiments of the present disclosure, the network device can indicate to the terminal device the configuration information of the reference signal being of one or more grades and used for the beam measurement, and then the terminal device can perform the beam measurement based on the configuration information of the reference signal in the first indication information, thereby achieving the reliable measurement on the beams being of one or more grades.

Reference is made to FIG. 3, in which a flowchart of a beam management method according to embodiments of the present disclosure is shown. The method is performed by a network device. As shown in FIG. 3, the method can include, but is not limited to, the following steps.

In step 301, first indication information is sent to a terminal device, the first indication information is configured to indicate configuration information of a reference signal used for a beam measurement, and the reference signal corresponds to one or more grades.

The specific implementations of step 301 in embodiments of the present disclosure can be found in the detailed description of any embodiment in the present disclosure, which will not be repeated here.

In step 302, third indication information is sent to the terminal device, and the third indication information is configured to indicate a measurement parameter.

In some embodiments of the present disclosure, the measurement parameter includes Reference Signal Received Power (RSRP), Reference Signal Received Quality (RSRQ), Signal to Interference plus Noise Ratio (SINR), Received Signal Strength Indicator (RSSI), etc., which is not limited by the present disclosure.

In some embodiments of the present disclosure, the network device can send the third indication information to the terminal device to indicate the measurement parameter. The terminal device can determine the measurement parameter of the reference signal based on the third indication information, and then measure the indicated and specified measurement parameter.

According to embodiments of the present disclosure, the network device can send to the terminal device the first indication information configured to indicate the configuration information of the reference signals corresponding to multiple grades and used for the beam measurement, and then send to the terminal device the third indication information configured to indicate the measurement parameter, thereby achieving the reliable measurement on the specified measurement parameter for the beams being of one or more grades.

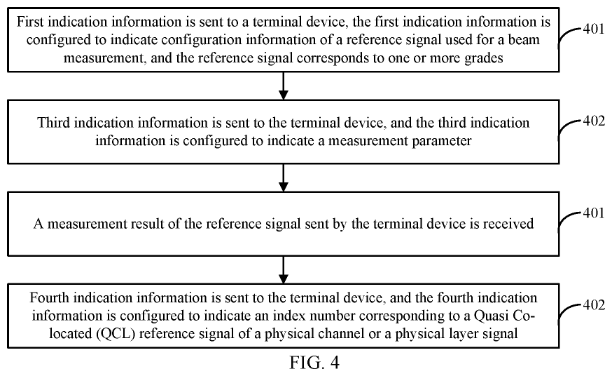

Reference is made to FIG. 4, in which a flowchart of a beam management method according to embodiments of the present disclosure is shown. The method is performed by a network device. As shown in FIG. 4, the method can include, but is not limited to, the following steps.

In step 401, first indication information is sent to a terminal device, the first indication information is configured to indicate configuration information of a reference signal used for a beam measurement, and the reference signal corresponds to one or more grades.

In step 402, third indication information is sent to the terminal device, and the third indication information is configured to indicate a measurement parameter.

The specific implementations of steps 401-402 in embodiments of the present disclosure can be found in the detailed description of any embodiment in the present disclosure, which will not be repeated here.

In step 403, a measurement result of the reference signal sent by the terminal device is received.

In some embodiments of the present disclosure, the measurement result can include at least one of a measurement value of the measurement parameter or identification information of the reference signal corresponding to the measurement parameter, which is not limited by the present disclosure.

In some embodiments of the present disclosure, the identification information of the reference signal corresponding to the measurement parameter can be used to uniquely determine the reference signal. The identification information can be the index number of the reference signal corresponding to the measurement parameter, etc., which is not limited by the present disclosure.

In some embodiments of the present disclosure, after completing the measurement on the measurement parameter based on the configuration information of the reference signal, the terminal device can generate the measurement result based on the measurement value of the measurement parameter and the identification information of the reference signal corresponding to the measurement parameter, and return the measurement result to the network device.

In some embodiments, in order to reduce the network resources occupied by the measurement result transmission, the measurement result can be sent to the network device only when a reporting condition is met. In some embodiments, the reporting condition for the measurement result can be configured by the network device or specified by protocols, which is not limited by the present disclosure.

In this way, the network device can determine based on the measurement result the beam that the terminal device can use for transmission.

In step 404, fourth indication information is sent to the terminal device, and the fourth indication information is configured to indicate an index number corresponding to a Quasi Co-located (QCL) reference signal of a physical channel or a physical layer signal.

In some embodiments of the present disclosure, the QCL reference signal is a reference signal that has a QCL relationship with the physical channel or the physical layer signal. The index number corresponding to the QCL reference signal can be a sequence number of the reference signal among all reference signals supported by the terminal device, or the index path of the reference signal in the grade tree. The grade tree includes index numbers being of multiple grades and the path relationships between each of the index numbers, and the beam widths corresponding to the index numbers being of different grades are different.

In some embodiments of the present disclosure, all reference signals can be uniformly numbered. Therefore, no matter what the beam width is, the reference signal each corresponds to a unique sequence number. That is, the sequence number of the reference signal among all reference signals supported by the terminal device can be determined as the index number corresponding to the reference signal.

In some embodiments of the present disclosure, based on the width of the beam corresponding to the reference signal, the grade based numbering can be used to classify and number the reference signal. As a result, each reference signal may correspond to multiple grade numbers. In some embodiments, the beams corresponding to the reference signals can be divided into grade A, grade B, and grade C, according to the beam widths corresponding to the reference signals. One beam being of grade A can include one or more beams being of grade B, and one beam being of grade B can include one or more beams being of grade C. In some embodiments, the beams being of the same grade can be numbered to form a tree structure. If the first A-grade beam includes two B-grade beams, and the second B-grade beam includes three C-grade beams, then for the C-grade beams, the grade number corresponding to the second C-grade beam is A1B2C2, and the grade number corresponding to the third C-grade beam is A1B2C3. In some embodiments, when the network device indicates A1B2C3, the terminal device can uniquely determine the reference signal A1B2C3 based on the index number. It should be noted that the above way of numbering the reference signals at each grade is only illustrative and cannot constitute a limitation on the grade based numbering scheme for the multiple grades of reference signals in the present disclosure.

According to embodiments of the present disclosure, the network device can send the fourth indication information to the terminal device to indicate the index number corresponding to the Quasi Co-located (QCL) reference signal of the physical channel or the physical layer signal. The terminal device determines the QCL reference signal corresponding to the physical channel or the physical layer signal based on the index number corresponding to the QCL reference signal in the fourth indication information, and then determines a receive beam for the physical channel or the physical layer signal based on a receive beam for the QCL reference signal, or determines an uplink transport beam based on the receive beam for the QCL reference signal.

In some embodiments, assuming that the network device has configured 100 reference signals for the terminal device, and the index numbers corresponding to the reference signals are single-grade numbers, ranging from 1 to 100. Based on the measurement result sent by the terminal device, the index number of the QCL reference signal corresponding to the physical channel or the physical layer signal is determined to be 88. Then, the network device can indicate the index number 88 of the QCL reference signal corresponding to the physical signal through the fourth indication information. As a result, the terminal device can determine the beam corresponding to the QCL reference signal as the available beam for the terminal device.

In some embodiments, in the case where the index numbers corresponding to the reference signals are multi-grade numbers, if the index number of the QCL reference signal corresponding to the physical channel or the physical layer signal is determined to be A1B2C3 based on the measurement result sent by the terminal device, the network device can then indicate the index number A1B2C3 of the QCL reference signal corresponding to the physical signal through the fourth indication information. As a result, the terminal device can determine the beam corresponding to the QCL reference signal as the available beam for the terminal device.

According to embodiments of the present disclosure, the network device can send to the terminal device the first indication information configured to indicate the configuration information of the reference signals corresponding to multiple grades and used for the beam measurement. The network device can then send to the terminal device the third indication information configured to indicate the measurement parameter, receive the measurement result of the reference signal sent by the terminal device, and send to the terminal device the fourth indication information configured to indicate the index number corresponding to the Quasi Co- located (QCL) reference signal corresponding to the physical channel or the physical layer signal, thereby achieving the reliable measurement on the specified measurement parameter for the beams being of one or more grades.

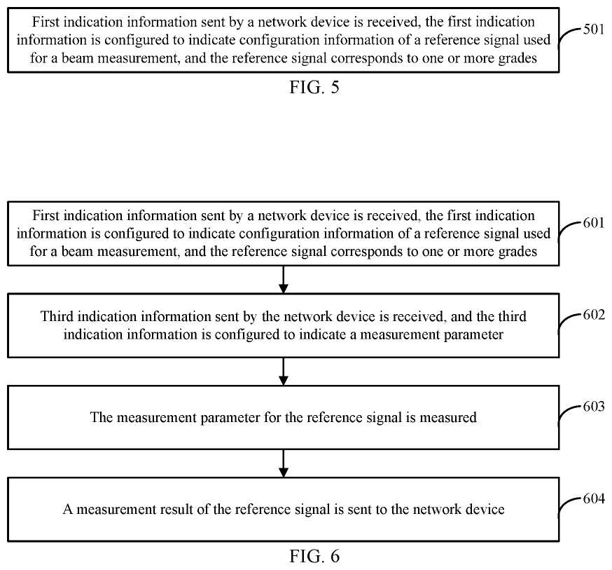

Reference is made to FIG. 5, in which a flowchart of a beam management method according to embodiments of the present disclosure is shown. The method is performed by a terminal device. As shown in FIG. 5, the method can include, but is not limited to, the following steps.

In step 501, first indication information sent by a network device is received, the first indication information is configured to indicate configuration information of a reference signal used for a beam measurement, and the reference signal corresponds to one or more grades.

In some embodiments of the present disclosure, in order to perform the beam measurement on millimeter waves or terahertz waves, the network device can configure multiple grades of reference signals used for measuring the millimeter waves, so as to indicate to the terminal device the configuration information of the reference signal corresponding to one or more grades. Based on the configuration information of the reference signal, the terminal device can complete the measurement on the millimeter waves.

In some embodiments of the present disclosure, the configuration information can include an index number corresponding to the reference signal, and a time domain position and a frequency domain position where the reference signal is located, etc., which is not limited by the present disclosure.

In some embodiments of the present disclosure, the index number corresponding to the reference signal can be used to determine the reference signal. The index number corresponding to the reference signal can correspond to the grade of the reference signal. Different index numbers represent different grades of reference signals. In some embodiments, if the grade of the reference signal is divided into grade one, grade two, and grade three, the index number corresponding to the reference signal can refer to an index path of the reference signal in a grade tree. The grade tree includes index numbers being of multiple grades and path relationships between each of the index numbers. The beam widths corresponding to the index numbers being of different grades are different.

In some embodiments, the grade corresponding to the reference signal can be determined based on the beam width of the reference signal, and the grade is configured to reflect the beam width of the reference signal.

In some embodiments, the grade value corresponding to the reference signal is correlated with the beam width of the reference signal. In some embodiments, if the grade value of the reference signal is positively correlated with the beam width, and the grade value of the reference signal includes grade one, grade two, and grade three, the beam width corresponding to the reference signal with a grade value of grade one has a wide width, the beam width corresponding to the reference signal with a grade value of grade two has a medium width, and the beam width corresponding to the reference signal with a grade value of grade three has a narrower width. In some embodiments, if the grade value of the reference signal is negatively correlated with the beam width, the beam width corresponding to the reference signal with a grade value of grade three has a wide width, the beam width corresponding to the reference signal with a grade value of grade two has a medium width, and the beam width corresponding to the reference signal with a grade value of grade one has a narrower width.

It should be noted that when the grade value is positively or negatively correlated with the beam width, the above corresponding relationship between the grade value and the beam width is only illustrative and cannot be used as a restrictive description related to the grade value and the beam width in the present disclosure.

In some embodiments, the network device can also send second indication information to the terminal device, and the second indication information is configured to indicate that a grade value corresponding to the reference signal is positively or negatively correlated with a beam width of the reference signal.

In this way, after receiving the second indication information, the terminal device can determine that the grade value corresponding to the reference signal is positively or negatively correlated with the beam width of the reference signal. The terminal device can then determine the beam width corresponding to the reference signal, based on the correlation relationship and the index number corresponding to the reference signal having been indicated.

According to embodiments of the present disclosure, the terminal device can receive the configuration information sent by the network device, which indicates the reference signal being of one or more grades and used for the beam measurement. The terminal device can then perform the beam measurement based on the configuration information of the reference signal in the first indication information, thereby achieving the reliable measurement on the beams being of one or more grades.

Reference is made to FIG. 6, in which a flowchart of a beam management method according to embodiments of the present disclosure is shown. The method is performed by a terminal device. As shown in FIG. 6, the method can include, but is not limited to, the following steps.

In step 601, first indication information sent by a network device is received, the first indication information is configured to indicate configuration information of a reference signal used for a beam measurement, and the reference signal corresponds to one or more grades.

The specific implementations of step 601 in embodiments of the present disclosure can be found in the detailed description of any embodiment in the present disclosure, which will not be repeated here.

In step 602, third indication information sent by the network device is received, and the third indication information is configured to indicate a measurement parameter.

In some embodiments of the present disclosure, the measurement parameter includes Reference Signal Received Power (RSRP), Reference Signal Received Quality (RSRQ), Signal to Interference plus Noise Ratio (SINR), Received Signal Strength Indicator (RSSI), etc., which is not limited by the present disclosure.

In some embodiments of the present disclosure, the network device can send the third indication information to the terminal device to indicate the measurement parameter. The terminal device can determine the measurement parameter of the reference signal based on the third indication information, and then measure the indicated and specified measurement parameter.

In step 603, the measurement parameter for the reference signal is measured.

In some embodiments of the present disclosure, after configuring reference signals for the terminal device, the network device can indicate to use any configured reference signal to measure a corresponding measurement parameter for the beam indicated. After completing the measurement, the terminal device can generate the measurement result based on the measurement value of the measurement parameter and the identification information of the reference signal corresponding to the measurement parameter.

In some embodiments of the present disclosure, the identification information of the reference signal corresponding to the measurement parameter can be used to uniquely determine the reference signal. The identification information can be the index number of the reference signal corresponding to the measurement parameter, etc., which is not limited by the present disclosure.

In step 604, a measurement result of the reference signal is sent to the network device.

In some embodiments of the present disclosure, the measurement result can include at least one of a measurement value of the measurement parameter or identification information of the reference signal corresponding to the measurement parameter, which is not limited by the present disclosure.

In some embodiments, in order to reduce the network resources occupied by the measurement result transmission, the measurement result can be sent to the network device only when a reporting condition is met. In some embodiments, the reporting condition for the measurement result can be configured by the network device or specified by protocols, which is not limited by the present disclosure.

In this way, the network device can determine based on the measurement result the beam that the terminal device can use for transmission.

According to embodiments of the present disclosure, after receiving the first indication information sent by the network device, which is configured to indicate the configuration information of the reference signal being of one or more grades and used for the beam measurement, the terminal device can receive the third indication information sent by the network device, which is configured to indicate the measurement parameter. The terminal device can then measure the measurement parameter for the reference signal and send the measurement result of the reference signal to the network device, thereby achieving the reliable measurement on the specified measurement parameter for the beams being of one or more grades.

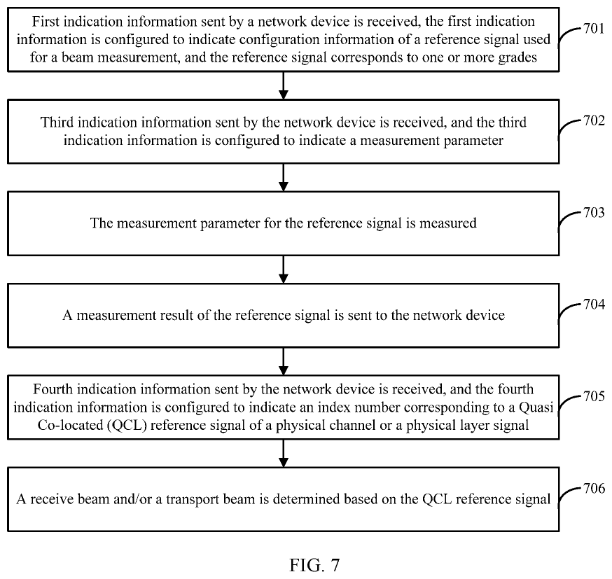

Reference is made to FIG. 7, in which a flowchart of a beam management method according to embodiments of the present disclosure is shown. The method is performed by a terminal device. As shown in FIG. 7, the method can include, but is not limited to, the following steps.

In step 701, first indication information sent by a network device is received, the first indication information is configured to indicate configuration information of a reference signal used for a beam measurement, and the reference signal corresponds to one or more grades.

In step 702, third indication information sent by the network device is received, and the third indication information is configured to indicate a measurement parameter.

In step 703, the measurement parameter for the reference signal is measured.

In step 704, a measurement result of the reference signal is sent to the network device.

The specific implementations of steps 701-704 in embodiments of the present disclosure can be found in the detailed description of any embodiment in the present disclosure, which will not be repeated here.

In step 705, fourth indication information sent by the network device is received, and the fourth indication information is configured to indicate an index number corresponding to a Quasi Co-located (QCL) reference signal of a physical channel or a physical layer signal.

In some embodiments of the present disclosure, the QCL reference signal is a reference signal that has a QCL relationship with the physical channel or the physical layer signal. The index number corresponding to the QCL reference signal can be a sequence number of the reference signal among all reference signals supported by the terminal device, or the index path of the reference signal in the grade tree. The grade tree includes index numbers being of multiple grades and the path relationships between each of the index numbers, and the beam widths corresponding to the index numbers being of different grades are different.

In some embodiments of the present disclosure, all reference signals can be uniformly numbered. Therefore, no matter what the beam width is, the reference signal each corresponds to a unique sequence number. That is, the sequence number of the reference signal among all reference signals supported by the terminal device can be determined as the index number corresponding to the reference signal.

In some embodiments of the present disclosure, based on the width of the beam corresponding to the reference signal, the grade based numbering can be used to classify and number the reference signal. As a result, each reference signal may correspond to multiple grade numbers. In some embodiments, the beams corresponding to the reference signals can be divided into grade A, grade B, and grade C, according to the beam widths corresponding to the reference signals. One beam being of grade A can include one or more beams being of grade B, and one beam being of grade B can include one or more beams being of grade C. In some embodiments, the beams being of the same grade can be numbered to form a tree structure. If the first A-grade beam includes two B-grade beams, and the second B-grade beam includes three C-grade beams, then for the C-grade beams, the grade number corresponding to the second C-grade beam is A1B2C2, and the grade number corresponding to the third C-grade beam is A1B2C3. In some embodiments, when the network device indicates A1B2C3, the terminal device can uniquely determine the reference signal A1B2C3 based on the index number. It should be noted that the above way of numbering the reference signals at each grade is only illustrative and cannot constitute a limitation on the grade based numbering scheme for the multiple grades of reference signals in the present disclosure.

According to embodiments of the present disclosure, the network device can send the fourth indication information to the terminal device to indicate the index number corresponding to the Quasi Co-located (QCL) reference signal of the physical channel or the physical layer signal. The terminal device determines the QCL reference signal corresponding to the physical channel or the physical layer signal based on the index number corresponding to the QCL reference signal in the fourth indication information, and then determines a receive beam for the physical channel or the physical layer signal based on a receive beam for the QCL reference signal, or determines a transport beam for the physical channel or the physical layer signal based on the receive beam for the QCL reference signal.

In some embodiments, assuming that the network device has configured 100 reference signals for the terminal device, and the index numbers corresponding to the reference signals are single-grade numbers, ranging from 1 to 100. Based on the measurement result sent by the terminal device, the index number of the QCL reference signal corresponding to the physical channel or the physical layer signal is determined to be 88. Then, the network device can indicate the index number 88 of the QCL reference signal corresponding to the physical signal through the fourth indication information.

In some embodiments, in the case where the index numbers corresponding to the reference signals are multi-grade numbers, if the index number of the QCL reference signal corresponding to the physical channel or the physical layer signal is determined to be A1B2C3 based on the measurement result sent by the terminal device, the network device can then indicate the index number A1B2C3 of the QCL reference signal corresponding to the physical signal through the fourth indication information. As a result, the terminal device can determine the beam corresponding to the QCL reference signal as the available beam for the terminal device.

In step 706, a receive beam and/or a transport beam is determined based on the QCL reference signal.

In some embodiments of the present disclosure, after determining the QCL reference signal, the terminal device can determine the receive beam corresponding to the QCL reference signal as the receive beam for the physical channel or the physical layer signal, or determine the transport beam for the physical channel or the physical layer signal based on the receive beam corresponding to the QCL reference signal.

According to embodiments of the present disclosure, after receiving the first indication information sent by the network device, which is configured to indicate the configuration information of the reference signal being of one or more grades and used for the beam measurement, the terminal device can receive the third indication information sent by the network device, which is configured to indicate the measurement parameter. The terminal device can then measure the measurement parameter for the reference signal and send the measurement result of the reference signal to the network device. Next, the terminal device can receive the fourth indication information sent by the network device, which is configured to indicate the index number corresponding to the Quasi Co-located (QCL) reference signal corresponding to the physical channel or the physical layer signal, and determine the receive beam and/or the transport beam based on the QCL reference signal, thereby achieving the reliable measurement on the specified measurement parameter for the beams being of one or more grades.

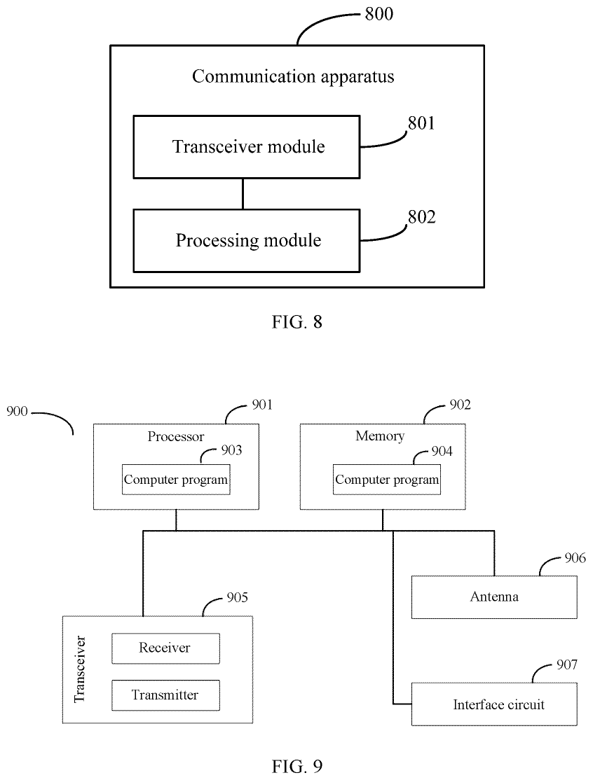

Reference is made to FIG. 8, in which is a schematic diagram of a structure of a communication apparatus 800 according to embodiments of the present disclosure is shown. The communication apparatus 800 shown in FIG. 8 can include a transceiver module 801 and a processing module 802. The transceiver module 801 can include a sending module and/or a receiving module. The sending module is configured to implement the sending function, and the receiving module is configured to implement the receiving function. The transceiver module 801 can implement the sending function and/or the receiving function.

It should be understood that the communication apparatus 800 can be a network device, an apparatus within the network device, or an apparatus that can be used in conjunction with the network device.

The communication apparatus 800 is on the network device side.

The transceiver module 801 is configured to send first indication information to a terminal device, with the first indication information being configured to indicate configuration information of a reference signal used for a beam measurement, and the reference signal corresponds to one or more grades.

In some embodiments, the configuration information includes at least one of an index number corresponding to the reference signal, or a time domain position and a frequency domain position where the reference signal is located.

In some embodiments, a grade value corresponding to the reference signal is correlated with a beam width of the reference signal.

In some embodiments, the transceiver module 801 is further configured to send second indication information to the terminal device, with the second indication information being configured to indicate that the grade value corresponding to the reference signal is positively or negatively correlated with the beam width of the reference signal.

In some embodiments, the transceiver module 801 is further configured to send third indication information to the terminal device, with the third indication information being configured to indicate a measurement parameter.

In some embodiments, the measurement parameter is at least one of Reference Signal Received Power (RSRP), Reference Signal Received Quality (RSRQ), Signal to Interference plus Noise Ratio (SINR), or Received Signal Strength Indicator (RSSI).

In some embodiments, the transceiver module 801 is further configured to receive a measurement result of the reference signal sent by the terminal device; and send fourth indication information to the terminal device, with the fourth indication information being configured to indicate an index number corresponding to a Quasi Co-located (QCL) reference signal of a physical channel or a physical layer signal.

In some embodiments, the index number corresponding to the reference signal is any one of: a sequence number of the reference signal among all reference signals supported by the terminal device; and an index path of the reference signal in a grade tree. The grade tree includes index numbers corresponding to multiple grades and path relationships between each of the index numbers, and the index numbers corresponding to different grades correspond to different beam widths.

In some embodiments, the measurement result includes at least one of a measurement value of the measurement parameter, or identification information of the reference signal corresponding to the measurement parameter.

It should be understood that communication apparatus 800 can be a terminal device, an apparatus within the terminal device, or an apparatus that can be used in conjunction with the terminal device.

The communication apparatus 800 is on the terminal device side.

The transceiver module 801 is configured to receive first indication information sent by a network device, with the first indication information being configured to indicate configuration information of a reference signal used for a beam measurement, and the reference signal corresponds to one or more grades.

In some embodiments, the configuration information includes at least one of an index number corresponding to the reference signal, or a time domain position and a frequency domain position where the reference signal is located.

In some embodiments, a grade value corresponding to the reference signal is correlated with a beam width of the reference signal.

In some embodiments, the transceiver module 801 is further configured to receive second indication information sent by the network device, with the second indication information being configured to indicate that the grade value corresponding to the reference signal is positively or negatively correlated with the beam width of the reference signal.

In some embodiments, the transceiver module 801 is further configured to receive third indication information sent by the network device, with the third indication information being configured to indicate a measurement parameter.

In some embodiments, the measurement parameter is at least one of Reference Signal Received Power (RSRP), Reference Signal Received Quality (RSRQ), Signal to Interference plus Noise Ratio (SINR), or Received Signal Strength Indicator (RSSI).

In some embodiments, the processing module 802 is configured to measure the measurement parameter for the reference signal.

The transceiver module is further configured to send a measurement result of the reference signal to the network device.

In some embodiments, the transceiver module 801 is further configured to receive fourth indication information sent by the network device, with the fourth indication information being configured to indicate an index number corresponding to a Quasi Co-located (QCL) reference signal of a physical channel or a physical layer signal.

The processing module 802 is further configured to determine a receive beam and/or a transport beam based on the QCL reference signal.

In some embodiments, the processing module 802 is specifically configured to determine the receive beam for the physical channel or the physical layer signal based on a receive beam corresponding to the QCL reference signal; and/or determine the transport beam for the physical channel or the physical layer signal based on the receive beam corresponding to the QCL reference signal.

In some embodiments, the index number corresponding to the reference signal is any one of: a sequence number of the reference signal among all reference signals supported by the terminal device; and an index path of the reference signal in a grade tree. The grade tree includes index numbers corresponding to multiple grades and path relationships between each of the index numbers, and the index numbers corresponding to different grades correspond to different beam widths.

In some embodiments, the measurement result includes at least one of a measurement value of the measurement parameter, or identification information of the reference signal corresponding to the measurement parameter.

According to embodiments of the present disclosure, the network device can indicate to the terminal device the configuration information of the reference signal being of one or more grades and used for the beam measurement, and then the terminal device can perform the beam measurement based on the configuration information of the reference signal in the first indication information, thereby achieving the reliable measurement on the beams being of one or more grades.

Reference is made to FIG. 9, in which a schematic diagram of a structure of a communication device 900 according to embodiments of the present disclosure is shown. The communication device 900 can be a network device, a terminal device, or a chip, a chip system, or a processor that supports the network device to implement the above methods, and the communication device 900 can also be a chip, a chip system, or a processor that supports the terminal device to implement the above methods. The communication device can be used to implement the methods described in the above method embodiments. Specifically, reference can be made to the description in the above method embodiments.

The communication device 1000 can include one or more processors 1001. The processor 1001 can be a general-purpose processor or a dedicated processor, etc. For example, the processor can be a baseband processor or a central processor. The baseband processor can be used to process communication protocols and communication data, and the central processor can be used to control the communication device (such as base stations, baseband chips, terminals, terminal chips, DU or CU, etc.), execute computer programs, and process computer program data.

In some embodiments, the communication device 1000 can also include one or more memories 1002, and a computer program 1004 can be stored on the memory. The processor 1001 can execute the computer program 1004 to cause the communication device 1000 to implement the methods described in the above embodiments. In some embodiments, the memory 1002 can also store data. The communication device 1000 and the memory 1002 can be arranged separately or integrated together.

In some embodiments, the communication device 1000 can also include a transceiver 1005 and an antenna 1006. The transceiver 1005 can be referred to as a transceiver unit, a transceiver machine, or a transceiver circuit, etc., and can be used to achieve a transceiving function. The transceiver 1005 can include a receiver and a transmitter. The receiver can be referred to as a receiver or a receiver circuit, etc., and is used to achieve a receiving function. The transmitter can be referred to as a transmitter or a transmitter circuit, etc., and is used to achieve a transmitting function.

In some embodiments, the communication device 1000 can also include one or more interface circuits 1007. The interface circuit 1007 is used to receive code instructions and transmit the code instructions to the processor 1001. The processor 1001 executes the code instructions to cause the communication device 1000 to implement the methods described in the above method embodiments.

The communication device 900 is a network device, and the transceiver 905 is used to execute steps 201 in FIGS. 2, 301 and 302 in FIGS. 3, 401, 402, 403 and 404 in FIG. 4, etc.

The communication device 900 is a terminal device, and the processor 901 is used to execute steps 603 in FIG. 6, 706 in FIG. 7, etc.

In some embodiments, the processor 1001 can include a transceiver for achieving receiving and transmitting functions. For example, the transceiver can be a transceiver circuit, an interface, or an interface circuit. The transceiver circuit, interface, or interface circuit used to achieve receiving and transmitting functions can be separate or integrated together. The above-mentioned transceiver circuit, interface or interface circuit can be used for reading and writing codes/data, or the above-mentioned transceiver circuit, interface or interface circuit can be used for transmitting or transferring signals.

In some embodiments, the processor 1001 can store a computer program 1003, which runs on the processor 1001 and causes the communication device 1000 to implement the methods described in the above embodiments. The computer program 1003 can be embedded in processor 1001, in which case the processor 1001 can be realized through hardware.

In some embodiments, the communication device 1000 can include a circuit that can achieve receiving, transmitting, or communicating functions as described in the above method embodiments. The processor and the transceiver described in the present disclosure can be realized on the integrated circuit (IC), analog IC, radio frequency integrated circuit (RFIC), mixed signal IC, application specific integrated circuit (ASIC), printed circuit board (PCB), electronic device, and the like. The processor and the transceiver can also be manufactured using various IC process technologies, such as complementary metal oxide semiconductor (CMOS), N-type metal oxide semiconductor (NMOS), P-type metal oxide semiconductor (PMOS), bipolar junction transistor (BJT), bipolar CMOS (BiCMOS), silicon germanium (SiGe), gallium arsenide (GaAs), etc.

The communication device described in the above embodiments can be a terminal, but the communication device described in the present disclosure is not limited to this, and the structure of the communication device may not be limited by FIG. 12. The communication device can be an independent device or can be part of a larger device. For example, the communication device can be at least one of:
(1) Independent integrated circuit ICs, or chips, or chip systems or subsystems.
(2) A set including one or more ICs, which can optionally also include storage components for storing data and computer programs.
(3) ASICs, for example, a modem.
(4) Modules that can be embedded in other devices.
(5) Receivers, terminals, intelligent terminals, cellular phones, wireless devices, handheld devices, mobile units, vehicle mounted devices, network side devices, cloud devices, artificial intelligence devices, etc.
(6) Other devices and so on.

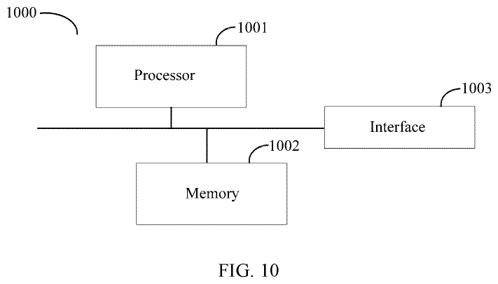

For the case where the communication device can be a chip or a chip system, reference is made to FIG. 10, in which a schematic diagram of a structure of a chip according to embodiments of the present disclosure is shown. The chip shown in FIG. 10 includes a processor 1001 and an interface 1003. In some embodiments, the number of processors 1001 can be one or more, and the number of interfaces 1003 can be multiple.

For the case where the chip is used to achieve the functions of the network device in some embodiments of the present disclosure, the interface 1003 is used to execute steps 201 in FIGS. 2, 301 and 302 in FIGS. 3, 401, 402, 403 and 404 in FIG. 4, etc.

For the case where the chip is used to achieve the functions of the terminal device in some embodiments of the present disclosure, the interface 1003 is used to execute steps 501 in FIGS. 5, 601, 602 and 604 in FIG. 6, 705 in FIG. 7, etc.

In some embodiments, the chip further includes a memory 1003, which is used for storing necessary computer programs and data.

Those skilled in the art can also understand that the various illustrative logical blocks and steps listed in the embodiments of the present disclosure can be achieved through electronic hardware, computer software, or a combination of both. Whether a function is achieved through hardware or software depends on the specific application and design requirements of the overall system. Those skilled in the art can use various methods to achieve the described functions for each specific application, but such achievement should not be understood as beyond the protection scope of the present disclosure.

The present disclosure also provides a readable storage medium on which instructions are stored, and when the instructions are executed by a computer, the functions of any of the above method embodiments are achieved.

The present disclosure also provides a computer program product that achieves the functions of any of the above method embodiments when executed by a computer.

The above embodiments can be fully or partially implemented through software, hardware, firmware, or any combination thereof. When implemented using software, the embodiments can be fully or partially implemented in the form of a computer program product. The computer program product includes one or more computer programs. When the computer programs are loaded and executed on the computer, all or part of the processes or functions described in the embodiments of the present disclosure are generated. The computer can be a general-purpose computer, a dedicated computer, a computer network, or other programmable devices. The computer program can be stored in a computer-readable storage medium or transmitted from one computer-readable storage medium to another. For example, the computer program can be transmitted from a website site, a computer, a server, or a data center via wired (such as coaxial cable, optical fiber, digital subscriber line (DSL)) or wireless (such as infrared, wireless, microwave, etc.) communication, to transmit to another website, computer, server, or data center. The computer-readable storage medium can be any available medium that the computer can access, or a data storage device such as a server, a data center, etc. that integrates one or more available media. The available media can be magnetic media (such as floppy disks, hard drives, magnetic tapes), optical media (such as high-density digital video discs (DVDs)), or semiconductor media (such as solid state disks (SSDs)), etc.

It can be understood that “multiple” in some embodiments of the present disclosure refers to two or more, and other quantifiers are similar to this. The expression “and/or” describes the association relationship between associated objects, indicating that there can be three types of relationships. For example, A and/or B, which can represent: A exists alone, A and B exist simultaneously, and B exists alone. The character “/” generally indicates an “or” relationship between the associated objects. The singular forms of “a”, “said”, and “the” are also intended to include the plural forms, unless clearly indicating otherwise in the context.

It can be further understood that although the operations are described in a specific order in the drawings in embodiments of the present disclosure, which should not be understood as it requires the execution of these operations in the specific order or the serial order shown, or requires the execution of all the operations shown to achieve the desired result. In specific environments, multitasking and parallel processing may be advantageous.

Those of ordinary skill in the art can understand that the first, second, and other numerical numbers involved in the present disclosure are only for the convenience of description and differentiation, and are not used to limit the scope of embodiments of the present disclosure, but also indicate an order.

At least one in the present disclosure can also be described as one or more, where more can be two, three, four, or more, which is not limited in the present disclosure. In embodiments of the present disclosure, “first”, “second”, “third”, “A”, “B”, “C”, and “D” can be used to distinguish different technical features described, and the technical features described using “first”, “second”, “third”, “A”, “B”, “C”, and “D” are not distinguished from each other in an order or a magnitude.

The corresponding relationships shown in each table in the present disclosure can be configured or predefined. The values of the information in each table are only examples and can be configured to other values, which is not limited in the present disclosure. When configuring the correspondence between information and various parameters, it is not necessary to configure all the correspondence shown in each table. For example, in the table of the present disclosure, the correspondence shown in certain rows may not be configured. For example, appropriate deformation adjustments can be made based on the above table, such as splitting, merging, etc. The names of the parameters shown in the titles of the above tables can also use other names that can be understood by the communication device, and the values or representations of the parameters can also use other values or representations that can be understood by the communication device. When implementing the above tables, other data structures can also be used, such as arrays, queues, containers, stacks, linear tables, pointers, linked lists, trees, graphs, structures, classes, heaps, hash tables, etc.

The term predefined in the present disclosure can be understood as defined, defined in advance, stored, stored in advance, negotiated in advance, configured in advance, solidified in advance, or fired in advance.

Those of ordinary skill in the art can realize that units and algorithm steps of each example described in embodiments of the present disclosure can be implemented in electronic hardware, or a combination of computer software and electronic hardware. Whether these functions are implemented in hardware or software depends on the specific application and design constraints of the technical solution. The skilled person can use different methods to achieve the described functions for each specific application, but such achievement should not be considered as beyond the scope of the present disclosure.

Those skilled in the art can clearly understand that for the convenience and conciseness of the description, the specific working processes of the system, device, and unit described above can refer to the corresponding processes in the above method embodiments, which will not be repeated here.

After considering the specification and practices of the present disclosure, those skilled in the art will easily come up with other implementation solutions of the present disclosure. The present disclosure aims to cover any variations, uses, or adaptive changes of the present disclosure, which follow the general principles of the present disclosure and include common knowledge or technical means commonly used in the art that are not disclosed in the present disclosure. The specification and embodiments are only considered exemplary, and the true scope and spirit of the present disclosure are defined by appended claims.

The above are only specific implementations of the present disclosure, but the protection scope of the present disclosure is not limited to this. Those changes or replacements that can be easily conceived by any skilled person familiar with the technical field within the scope of the present disclosure, should be within the protection scope of the present disclosure. Therefore, the protection scope of the present disclosure should be based on the protection scope of appended claims.

1. A beam management method, performed by a network device, the method comprising:
sending first indication information to a terminal device, wherein the first indication information is configured to indicate configuration information of a reference signal used for a beam measurement, and wherein the reference signal corresponds to one or more grades.

2. The method according to claim 1, wherein the configuration information comprises at least one of an index number corresponding to the reference signal, or a time domain position and a frequency domain position where the reference signal is located.

3. The method according to claim 1, wherein a grade value corresponding to the reference signal is correlated with a beam width of the reference signal.

4. The method according to claim 3, further comprising:
sending second indication information to the terminal device, wherein the second indication information is configured to indicate that the grade value corresponding to the reference signal is positively or negatively correlated with the beam width of the reference signal.

5. The method according to claim 1, further comprising:
sending third indication information to the terminal device, wherein the third indication information is configured to indicate a measurement parameter.

6. The method according to claim 5, wherein the measurement parameter comprises at least one of Reference Signal Received Power (RSRP), Reference Signal Received Quality (RSRQ), Signal to Interference plus Noise Ratio (SINR), or Received Signal Strength Indicator (RSSI).

7. The method according to claim 1, further comprising:
receiving a measurement result of the reference signal sent by the terminal device; and
sending fourth indication information to the terminal device, wherein the fourth indication information is configured to indicate an index number corresponding to a Quasi Co-located (QCL) reference signal of a physical channel or a physical layer signal.

8. The method according to claim 2, wherein the index number corresponding to the reference signal comprises one of:
a sequence number of the reference signal among all reference signals supported by the terminal device; and
an index path of the reference signal in a grade tree, wherein the grade tree comprises index numbers corresponding to multiple grades and path relationships between each of the index numbers, and wherein the index numbers corresponding to different grades correspond to different beam widths.

9. The method according to claim 7, wherein the measurement result comprises at least one of a measurement value of the measurement parameter, or identification information of the reference signal corresponding to the measurement parameter.

10. A beam management method, performed by a terminal device, the method comprising:
receiving first indication information sent by a network device, wherein the first indication information is configured to indicate configuration information of a reference signal used for a beam measurement, and wherein the reference signal corresponds to one or more grades.

11. The method according to claim 10, wherein the configuration information comprises at least one of an index number corresponding to the reference signal, or a time domain position and a frequency domain position where the reference signal is located.

12. The method according to claim 10, wherein a grade value corresponding to the reference signal is correlated with a beam width of the reference signal.

13. The method according to claim 12, further comprising:
receiving second indication information sent by the network device, wherein the second indication information is configured to indicate that the grade value corresponding to the reference signal is positively or negatively correlated with the beam width of the reference signal.

14. The method according to claim 10, further comprising:
receiving third indication information sent by the network device, wherein the third indication information is configured to indicate a measurement parameter, and wherein the measurement parameter comprises at least one of Reference Signal Received Power (RSRP), Reference Signal Received Quality (RSRQ), Signal to Interference plus Noise Ratio (SINR), or Received Signal Strength Indicator (RSSI).

15. (canceled)

16. The method according to claim 14, further comprising:
measuring the measurement parameter for the reference signal; and
sending a measurement result of the reference signal to the network device,
wherein the measurement result comprises at least one of a measurement value of the measurement parameter, or identification information of the reference signal corresponding to the measurement parameter.

17. The method according to claim 16, further comprising:
receiving fourth indication information sent by the network device, wherein the fourth indication information is configured to indicate an index number corresponding to a Quasi Co-located (QCL) reference signal of a physical channel or a physical layer signal; and
determining at least one of a receive beam or a transport beam based on the QCL reference signal.

18. The method according to claim 17, wherein determining the at least one of the receive beam or the transport beam based on the QCL reference signal, comprises at least one of:
determining the receive beam for the physical channel or the physical layer signal based on a receive beam corresponding to the QCL reference signal; or
determining the transport beam for the physical channel or the physical layer signal based on the receive beam corresponding to the QCL reference signal.

19. The method according to claim 16, wherein the index number corresponding to the reference signal comprises one of:
a sequence number of the reference signal among all reference signals supported by the terminal device; and
an index path of the reference signal in a grade tree, wherein the grade tree comprises index numbers corresponding to multiple grades and path relationships between each of the index numbers, and wherein the index numbers corresponding to different grades correspond to different beam widths.

20-40. (canceled)

41. A communication device, comprising a processor and a memory, wherein a computer program is stored in the memory, and the processor is configured to execute the computer program stored in the memory to implement a beam management method comprising:
sending first indication information to a terminal device, wherein the first indication information is configured to indicate configuration information of a reference signal used for a beam measurement, and wherein the reference signal corresponds to one or more grades.

42. (canceled)

43. A communication device, comprising a processor and a memory, wherein a computer program is stored in the memory, and the processor is configured to execute the computer program stored in the memory to cause the device to implement the method according to claim 10.
